(19) United States
(12) Patent Application Publication
(10) Pub. No.: US 2003/0079561 A1
(43) Pub. Date: May 1, 2003

(54) Selector lever protection device for a selector lever of an automatic transmission

(75) Inventors: Kai Schmidt, Bendestorf (DE); Armin Segeler, Gruenendeich (DE)

Correspondence Address: CROWELL & MORING LLP, INTELLECTUAL PROPERTY GROUP, P.O. BOX 14300, WASHINGTON, DC, 20044-4300, US

(73) Assignee: DaimlerChrysler AG

(21) Appl. No.: 10/269,083

(22) Filed: Oct. 11, 2002

(30) Foreign Application Priority Data
Oct. 13, 2001 (DE) 101 50 718.6-14

(51) Int. Cl. G05G 5/00; F16H 59/00

(52) U.S. Cl. 74/473.23

(57) ABSTRACT

A selector lever protection device for a selector lever of an automatic transmission includes a locking element, which is assigned a locking member that can be released by means of a brake actuation switch or an ignition lock switch and is in operative connection with a final control element, the final control element being designed as a static or immobile final control element, such as a magnetic clamp, and it being possible for the locking member to be set to a locking position I by the final control element and to a state that differs from this locking position I and in which it is free of forces and/or loads.

This application claims the priority of German Patent Document No. 101 50 718.6, filed Oct. 13, 2001, the disclosure of which is expressly incorporated by reference herein.

### BACKGROUND AND SUMMARY OF THE INVENTION

The invention relates to a selector lever protection device for a selector lever of an automatic transmission with a locking element having a locking member that can be released by a brake actuation switch or an ignition lock switch, the locking member being in operative connection with a final control element.

DE 196 01 442 A1 discloses a selector lever lock for a shift system of an automatic transmission, in which locking members actuated by electromagnets lock the selector lever in a park position P and in a neutral position N. The locking member, which is effective in the P position is releasable by an ignition key, which can be inserted into an ignition lock. A holding element holds the ignition key fast in the ignition lock and releases it only in the P position.

U.S. Pat. No. 4,473,141 discloses a selector lever control arrangement which has a locking member for a gate pin. The locking member prevents the selector lever moving from a reverse position R into a park position P unless an ignition switch and a brake switch are closed. For this purpose, the locking member has an actuating device in the form of a combination of a spring and a solenoid. The spring presses the locking member continuously towards the locking position, while the solenoid frees the path for the gate pin within the gate when the control switches are closed. To avoid a critical position between P and R, the locking member has a chamfer, which engages on the gate pin and, owing to the spring force or the resultant spring force, pushes it out of a critical position into the P position. In addition, the gate pin has a recess, which, in conjunction with a position switch of the locking member, acoustically indicates the critical position of the selector lever and avoids a movement back into the R position.

An object of the invention is to design and arrange a selector lever protection device in such a way that a defined position of the selector lever is ensured in a simple and economical manner.

According to the invention, the object is achieved by designing the final control element as a static or immobile final control element, such as a magnetic clamp. In addition, the locking member can be set to a defined or fixed locking position I by the final control element and to a state that differs from this locking position I, in which it is free of forces and/or loads. This ensures that the interlock forces of the locking needle are independent of the locking force of the locking member, e.g. the holding force of the magnetic clamp. The locking member can thus be of small and lightweight design, while protecting the selector lever.

For this purpose, the locking member may have two operating states or can be moved into two operating states, one state in a fixed locking position I and another state that differs from this locking position I, in which it is free of forces and/or loads. It is possible for the locking member to be fixed in the locking position by the final control element and is free of forces and/or loads in every other position. This ensures that the final control element of the locking member can be designed as a simple, lightweight and advantageous holding member or fixing member. It is not necessary to construct it as an active final control element that allows the locking member to be shifted or moved.

According to a development, an additional possibility is for the locking member to have an elastic bearing element, which is in operative connection with the locking element. The locking element is designed as a locking needle that can be displaced parallel to a selector-lever center line, and the bearing element is designed as a spring and/or damper. This enables the unlocking movement of the locking element to be performed against the spring force, despite the selector lever protection device being effective. The unlocking movement thus remains ineffective while the locking member is active insofar as the spring is preloaded.

It is also advantageous for this purpose that the locking member is in operative connection with a locking contour and/or with it forms a common bearing element, and the locking member is arranged in such a way as to be rotatable, pivotable or translatable by a bearing. The bearing is designed as a pivot bearing with a pivot. The necessary locking contour is thus complemented by the locking member to achieve the protective effect and can be pivoted in a simple manner by releasing the locking member.

In connection with a design and arrangement according to the invention, it is advantageous that the locking member has an imbalance in relation to its pivot, a return spring and/or a return moment, and/or the pivot is arranged asymmetrically on the locking member. As a result, the locking member, which has been pivoted owing to the bearing of the locking element on the spring or the unlocking movement of the element, is always set to a position very close to the fixed position I, allowing the locking member to be fixed at any time by the final control element.

It is furthermore advantageous that, in the fixed state of the locking member, the locking member and the locking contour form a common locking surface for the locking element, it being possible, in the released, force-free state of the locking member, for the selector lever to be moved with the locking element out of a park position P or another position into a reverse position R, past the locking contour.

It is furthermore advantageous that, in the park position P of the selector lever, the latter is fixed in its position by the locking element and the locking contour. The locking member, together with the locking contour, against which it rests, locks the locking element positively in each of its positions. When the locking element is actuated, it comes to rest against the spring of the locking member and is moved counter to the spring force into a position below or to the side of the locking contour. When the locking member is released from the final control element, the locking member is pivoted in such a way, owing to the contact between the locking element and the spring, that the locking member releases the locking element and the latter can be moved past the locking contour. Owing to the imbalance of the locking member or to a return element, the locking member is set to a position, very close to the locking position, in which it can be fixed by the final control element.

In addition to the exemplary embodiments described below, a fixed locking needle is also provided in the positions shown in FIGS. 2 and 3, respectively, i.e. at the level of the recess of the locking member. The shift lever can thus be moved sideways only after the locking member has been pivoted into position II. In this case, the locking contour is not necessary. During a sideways movement of the shift lever and the locking needle relative to the locking member, the locking needle initially rests against the spring of the locking member. Owing to the sideways movement, the spring is subjected to the maximum preload, and it is only after this that the locking needle comes to rest against the locking surface of the locking member. As soon as the locking member has been released by the final control element, the locking member pivots into the inactive position II owing to the applied spring preloading force. The selector lever or the locking needle can thus be moved to the left, past the locking surface of the pivoted locking member, as shown in FIG. 2.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a selector lever protection device with a locking lever, a holding magnet and an operating spring in the locked state,

FIG. 2 shows a selector lever protection device with a locking lever, a holding magnet and an operating spring in the locked state,

FIG. 3 shows a selector lever protection device with a locking lever, a holding magnet and an operating spring in the locked state with the locking needle actuated.

### DETAILED DESCRIPTION OF THE DRAWINGS

FIG. 1 illustrates a selector lever protection device 1, which has a locking member 4 for a locking element or locking needle 3 of a selector lever 2 of a motor-vehicle transmission.

The locking member 4 is essentially formed by two parallel limbs 12, 12′, which are connected to one another in the region of a bearing 8 and are arranged pivotably by this common bearing 8 or a pivot 9. According to FIG. 1, the locking member 4 accordingly has a Z- or double-L-shaped cross section. The bearing 8 is situated in the corner region of the locking member 4 or of a limb 12′. In this arrangement, one limb 12 is in operative connection with a final control element 5, i.e. it is fixed in a position I and secured on the limb 12 by the final control element 5. For this purpose, the final control element 5 is designed as a magnetic clamp, which fixes the locking member 4 in the almost horizontal position I in accordance with FIG. 1. At the same time, the limb 12 is flat, at least on its contact surface 13 corresponding to the final control element 5, ensuring that the magnetic clamp 5 has an adequate retaining effect. The second limb 12′ has a bearing surface 14, which corresponds to a locking contour 6 and, in the locked position I of the locking member 4, at least almost rests against the locking contour 6. The locking contour 6 is of rectangular cross section, two sides being connected in an arc or forming an arc-shaped chamfer. One of the side faces forms a bearing surface 14′. A groove or recess is provided in the bearing surface 14′ of the locking contour 6 in such a way that, when the two bearing surfaces 14, 14′ are in contact, these two bearing surfaces 14, 14′ overlap. A recess 15 of triangular cross section, which is approximately half the height of the limb 12′, is furthermore provided at the outer end of the limb 12′. The recess 15 is assigned a leaf spring 7. The leaf spring 7 is secured on the end 16 of the limb 12′ and extends over the recess 15 or closes the recess 15 in such a way that the locking needle 3 cannot readily be moved into the recess 15. Moreover, the recess 15 of the locking member 4 has a locking surface 11 that complements the locking contour 6 and against which the locking needle 3 comes to rest in the fixed position I when the selector lever is moved.

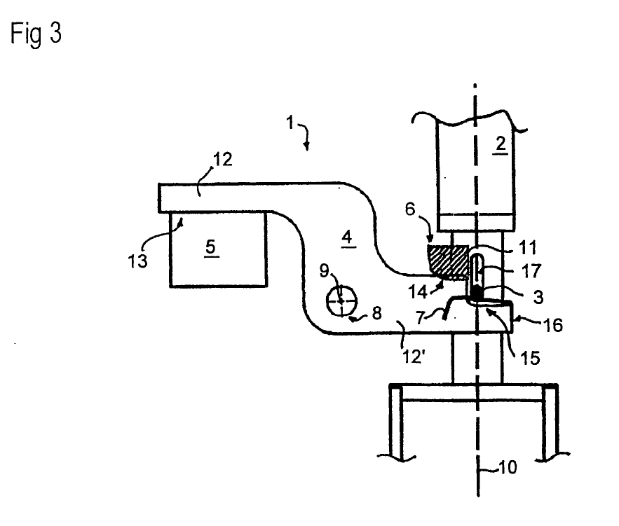

The locking needle 3 is arranged in a moveable manner within a longitudinal groove 17 of the selector lever 2, allowing it to be moved in the region of the common locking surface 11 of the locking contour 6 and the locking member 4 when the locking member 4 is fixed. During this movement of the locking needle 3, it rests against the spring 7, i.e. the locking needle 3 is moved by a manual operating movement counter to the spring force of the spring 7 in accordance with FIG. 3 from an upper rest position into a lower operating position. During this process, the spring force resulting from the preloaded spring 7 is introduced into the locking member 4. As long as the locking member 4 is fixed, the spring force applied is absorbed by the retaining force of the final control element 5. The locking member 4 is fixed in its locking position I, and the locking needle 3 is prevented from performing a sideways motion, past the locking contour, by the locking surface 11 of the locking member 4.

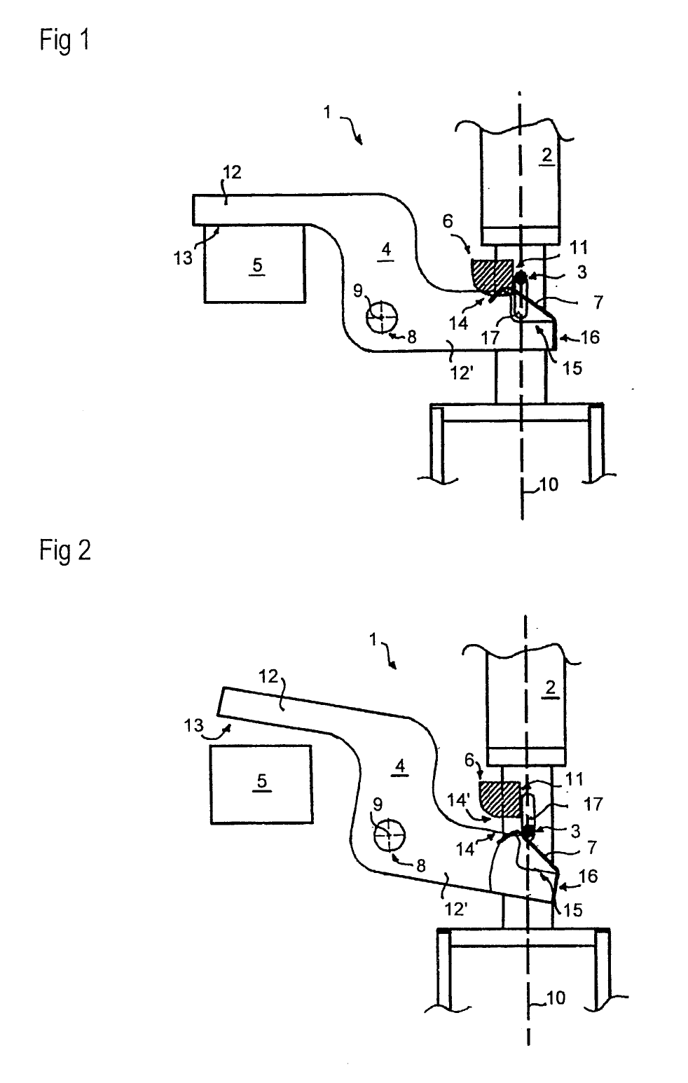

As soon as the final control element is deactivated, in accordance with FIG. 2, the locking member 4 pivots into a free, inactive position II owing to the actuating force introduced via the locking needle 3 and the spring 7. The locking needle 3 can thus follow a sideways motion of the selector lever within a selector lever slot (not shown), past the bearing surfaces 14, 14′, by virtue of the fact that the locking surface 11 is now open.

Owing to an imbalance of the locking member 4 or to a return element (not shown), the locking member is always set to a position very close to the locking position I, in which it can be fixed by the final control element.

What is claimed:

1. A selector lever protection device for a selector lever of an automatic transmission, the device comprising:
a locking element;
a locking member in operative relationship with the locking element, the locking member having a fixed locking position I; and
a static or immobile final control element being engageable with the locking member based on the state of a brake actuation switch or an ignition lock switch, wherein the locking member is at the locking position I when the locking member is engaged with the final control element, and wherein the locking member is not at the locking position I and is free of force or load when the locking member is disengaged with the final control element.

2. The device according to claim 1, wherein the locking member has an elastic bearing element, which is in operative connection with the locking element.

3. The device according to claim 2, wherein the locking element includes a locking needle that is displaceable parallel to a selector-lever center line, and the elastic bearing element includes at least one of a spring and a damper.

4. The device according to claim 1, further comprising a locking contour, wherein the locking member is in operative connection with the locking contour, and the locking member and the locking contour form a common bearing element.

5. The device according to claim 1, further comprising a bearing, wherein the locking member is rotatable, pivotable or translatable about the bearing.

6. The device according to claim 5, wherein the bearing includes a pivot bearing with a pivot.

7. The device according to claim 6, wherein the locking member has an imbalance in relation to the pivot.

8. The device according to claim 6, wherein the locking member has a return spring or a return moment.

9. The device according to claim 6, wherein the pivot is arranged asymmetrically with respect to the locking member.

10. The device according to claim 4, wherein when the locking member is at the locking position I, the locking member and the locking contour form a common locking surface for the locking element, and wherein when the locking member is not at the locking position I, the selector lever is moveable with the locking element past the locking contour out of a park position P or another position into a reverse position R.

11. The device according to claim 1, wherein the final control element includes a magnetic clamp.

12. A method for securing a selector lever within a locking contour, the method comprising:
in a park position P of the selector lever, fixing the selector lever in its position using a locking element and the locking contour, a locking member, together with the locking contour, against which it rests, locking the locking element positively in each of its positions.
actuating the locking element so it comes to rest against the spring of the locking member and is moved counter to the spring force into a position below or to the side of the locking contour.
releasing the locking member from the final control element so that the locking member pivots in such a way, owing to the contact between the locking element and the spring, that the locking member releases the locking element and the latter can be moved past the locking contour.
owing to the imbalance of the locking member or to a return element, setting the locking member in a position, very close to the locking position, in which it can be fixed by the final control element.
